(19) United States
(12) Patent Application Publication
(10) Pub. No.: US 2014/0295267 A1
(43) Pub. Date: Oct. 2, 2014

(54) SILICON BASED COMPOSITE MATERIAL, AND PREPARATION METHOD AND USE THEREOF

(71) Applicants: Ningde Amperex Technology Limited, Dongguan (CN); Dongguan Amperex Technology Limited, Dongguan (CN)

(72) Inventor: Na WANG, Dongguan (CN)

(73) Assignees: Ningde Amperex Technology Limited, Dongguan (CN); Dongguan Amperex Technology Limited, Dongguan (CN)

(21) Appl. No.: 14/242,773

(22) Filed: Apr. 1, 2014

(30) Foreign Application Priority Data
Apr. 2, 2013 (CN) 201310113033.2

(51) Int. Cl. H01M 4/36; H01M 4/38; H01M 4/60

(52) U.S. Cl. CPC H01M 4/366; H01M 4/606; H01M 4/386
USPC 429/213; 427/58

(57) ABSTRACT

The present disclosure provides a silicon based composite material, and a preparation method and a use thereof. The silicon based composite material comprises silicon nano-particles and polyaniline coating layers on surfaces of the silicon nano-particles, and Si—C covalent bonds are formed between the silicon nano-particles and the polyaniline coating layers. The silicon based composite material provided by the present disclosure is advantageous in improving the coating effect of polyaniline on silicon particles.

### CROSS-REFERENCE TO RELATED APPLICATIONS

The present application claims priority to Chinese patent application No. 201310113033.2 filed on Apr. 2, 2013, which is incorporated herein by reference in its entirety.

### FIELD OF THE PRESENT DISCLOSURE

The present disclosure relates to field of lithium-ion battery, and more particularly to a to silicon based composite material, and a preparation method and a use thereof.

### BACKGROUND OF THE PRESENT DISCLOSURE

Currently, most of electrodes of commercial lithium-ion batteries employ lithium transition metal oxide/graphite system. Since theoretical lithium intercalation capacity of graphite itself (which only is 372 mAh/g) in the system is relatively low, and it is difficult to increase energy density only by improvement on design structure and manufacturing process of batteries, a negative electrode active material having higher specific energy is required. Research on non-carbonic negative electrode active material appears in field of the negative electrode active material of the lithium-ion battery, some elements such as Aluminum (Al), Silicon (Si), Antimony (Sb), Stannum (Sn) and the like, may be alloyed with lithium metal, the alloy has storage capability of lithium-ion and has considerably high reversible intercalation capacity relative to the graphite negative electrode active material. However, the alloy negative electrode active materials have defects which are mainly focused on a serious volume effect resulting in a poor cycle stability, so as to block practicality of the materials. Therefore, promoting practicality of the materials becomes hot in current researches on the negative electrode active material of lithium-ion batteries.

In the various alloy negative electrode active materials, silicon based material has a relatively high theoretical lithium intercalation capacity (e.g., the theoretical lithium intercalation capacity of silicon is 4200 mAh/g) and a low intercalation potential. If the silicon based negative electrode active material is capable to be successfully applied to field of lithium-ion batteries, it is certain for the lithium-ion batteries to bring a great progress. Though the silicon based negative electrode active material has a relatively high theoretical lithium intercalation capacity, there is a great change in volume during deep intercalation-deintercalation of lithium-ion, this results in that structure thereof has a poor stability during lithium intercalation-deintercalation and charge/discharge efficiency is low for the first time, so that an application thereof is limited in lithium-ion batteries.

Therefore, in order to reduce the effect of the silicon based negative electrode active material in volume during lithium intercalation-deintercalation, research fellow would mix a silicon material with a conductive polymer, on the one hand, advantage of high lithium intercalation specific capacity for the silicon material may be maintained; on the other hand, change thereof in volume is suppressed by using conductivity of the conductive polymer and a long-chain structure of the polymer. For example, a silicon-containing composite material and a preparation method and a use thereof are disclosed by Chinese patent application publication No. CN101210119A. A weight ratio of silicon to a conductive polymer in the composite material is 0.2˜10:1, electric conductivity of the conductive polymer is 1˜100 S/cm. In the method, the conductive polymer is directly taken as the coating layer without reprocessing the material by using pyrolysis step, carbonisation step and like, but the coating effect of the conductive polymer on silicon can not be ensured, which results in that the silicon composite material has a poor cycle life. And a silicon-containing composite material and a preparation method and a use thereof are also disclosed by Chinese patent application publication No. CN101210112A. The silicon-containing composite material, on the basis of Chinese patent application publication No. CN101210119A, is added with a graphite composition. Though cycle life of the material is prolonged, advantage of high specific capacity for the silicon material is basically lost.

In the prior art of phenylamine polymerization, it is necessary to conduct polymerization at low temperature (<5 celsius degree), thereby being capable to ensure final electronic conductivity of polyaniline. Since speed of polymerization is too fast at room temperature, this causes polymerization degree of phenylamine too high so that electronic conductivity of polyaniline is lowered, so that electronic conductivity for silicon/polyaniline composite material is reduced as a whole. In Chinese patent application publication No. CN 101210119A and CN101210112A, reaction temperature is not mentioned but is simply described as a well known condition in the art, that is to say, it is shown that temperature for synthesis is not be improved and controlled. In Chinese patent application publication No. CN 101210119A and CN101210112A, description of polymerization process simply is that nano-silicon particles are directly mixed with phenylamine monomer by a way of physical stirring, immediately followed that phenylamine is directly polymerized in the mixing solution. As for the coating effect, there is no any improvement and control, in this way, even if the composite material is obtained, it is difficult to keep products using the material consistent.

### SUMMARY OF THE PRESENT DISCLOSURE

In view of the problems in the background art, an object of the present disclosure is to provide a silicon based composite material, and a preparation method and a use thereof which may improve the silicon based composite material in the coating effect.

Another object of the present disclosure is to provide a silicon based composite material, and a preparation method and a use thereof; the silicon based composite material is capable to improve lithium deintercalation capacity per gram and prolong cycle retention rate for a lithium-ion battery when applied to the lithium-ion battery as a negative electrode active material.

In order to achieve the above-mentioned objects, in a first aspect of the present disclosure, the present disclosure provides a silicon based composite material comprising silicon nano-particles and polyaniline coating layers on surfaces of the silicon nano-particles, and Si—C covalent bonds are formed between the silicon nano-particles and the polyaniline coating layers.

In a second aspect of the present disclosure, the present disclosure provides a preparation method of a silicon based composite material, which is used to prepare the silicon based composite material according to the first aspect of the present disclosure, which comprises steps of: conducting diazotization reaction under nitrite and an acidic condition by using p-phenylenediamine (H₂N—Ar—NH₂) to generate diazonium salt; conducting substitution reaction by adding silicon nano-particles into a solution in which the diazotization reaction has achieved, to obtain a nano-silicon based precursor in which phenylamine monomers are linked to surfaces of the silicon nano-particles by Si—C covalent bonds; adding the nano-silicon based precursor into microemulsion formed by mixing an oil phase with a water phase, adjusting pH of the microemulsion, and then adding phenylamine monomer; conducting polymerization reaction of phenylamine by adding an initiator polymerizing phenylamine into the microemulsion, to obtain the silicon based composite material in which the surfaces of the silicon nano-particles are coated with polyaniline layers.

In a third aspect of the present disclosure, the present disclosure provides a use of the silicon based composite material provided in the first aspect as a negative electrode active material for a lithium-ion battery.

The beneficial effects of the present disclosure are as follows:

In the present disclosure, phenylamine monomer is preferentially grafted to the surfaces of the silicon nano-particles by diazotization reaction before polymerization reaction of phenylamine, and then polymerization reaction of phenylamine is conducted under a polymerizing condition with microemulsion, so that linking between polyaniline layers and the silicon nano-particles is not by surface physical way but by covalent bond, so that the silicon based composite material has a better coating effect and an improved hardness and binding energy for an anode material.

The oil phase is taken as shell and the water phase is taken as core in the polymerizing condition with microemulsion of the present disclosure, the entirely polymerizing condition is dispersed to decrease polymerizing speed for phenylamine, so that the reaction which originally has to be conducted at low temperature may be conducted at room temperature while ensuring electronic conductivity for polyaniline.

Stability in structure for the silicon based composite material of the present disclosure is good, change of the silicon nano-particles in volume is slowed down greatly during cycles, therefore, cycle retention rate thereof is increased; meanwhile connectivity for electronic conductivity between the silicon nano-particles and polyaniline layers is enhanced, since the silicon nano-particles and polyaniline layers are bonded by covalent bonds, so that the silicon based composite material has a relatively high electric conductivity, and lithium deintercalation capacity per gram for the lithium-ion battery is improved.

### BRIEF DESCRIPTION OF THE FIGURES

FIG. 1 was Scanning Electron Microscopy (SEM) and Transmission Electron Microscope (TEM) photographs of a silicon based composite material of example 1, where (a) was a SEM photograph and (b) was a TEM photograph;

FIG. 2 was SEM and TEM photographs of a silicon based composite material of comparative example 1, where (a) was a SEM photograph and (b) was a TEM photograph;

FIG. 3 was XPS characterization of nano-silicon particles before and after diazotization reaction and substitution reaction.

### DETAILED DESCRIPTION

Hereinafter, embodiments of a silicon based composite material, and a preparation method and the use thereof according to the present disclosure, will be described in details.

Firstly, a silicon based composite material according to a first aspect of the present disclosure will be described.

A silicon based composite material according to a first aspect of the present disclosure comprises silicon nano-particles and polyaniline coating layers on surfaces of the silicon nano-particles, and Si—C covalent bonds are formed between the silicon nano-particles and the polyaniline coating layers.

Si—C covalent bond may be represented as

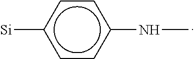

In the silicon based composite material according to the first aspect of the present disclosure, an electric conductivity of the silicon based composite material is 1˜6.5 S/cm, preferably 1.98˜4.63 S/cm.

In the silicon based composite material according to the first aspect of the present disclosure, preferably, a particle size D50 of the silicon nano-particles is 10˜100 nm.

In the silicon based composite material according to the first aspect of the present disclosure, preferably, in the silicon based composite material, a weight ratio of the silicon nano-particles to polyaniline layers is (45˜85):(55˜15).

In the silicon based composite material according to the first aspect of the present disclosure, preferably, a hardness of the silicon based composite material is 1.4˜3.5 GPa, preferably 2.6˜3.5 GPa.

Secondly, a preparation method of a silicon based composite material according to a second aspect of the present disclosure will be described.

A preparation method of a silicon based composite material according to a second aspect of the present disclosure for preparing the silicon based composite material according to the first aspect of the present disclosure, comprises steps of: conducting diazotization reaction under nitrite and an acidic condition by using p-phenylenediamine (H₂N—Ar—NH₂) to generate diazonium salt; conducting substitution reaction by adding silicon nano-particles into a solution in which the diazotization reaction has achieved, to obtain a nano-silicon based precursor in which phenylamine monomers are linked to surfaces of the silicon nano-particles by Si—C covalent bonds; adding the nano-silicon based precursor into microemulsion formed by mixing an oil phase with a water phase, adjusting pH of the microemulsion, and then adding phenylamine monomer; conducting polymerization reaction of phenylamine by adding an initiator polymerizing phenylamine into the microemulsion, to obtain the silicon based composite material in which polyaniline layers is linked to the surfaces of the silicon nano-particles by Si—C covalent bonds.

P-phenylenediamine is reacted with nitrite which acts as an initiator under the acidic condition to generate diazo compound with azo structure; since the silicon nano-particles has a plurality of functional groups formed by nature such as carboxyl (—COOH) and hydroxyl (—OH) at the surface thereof, where hydroxyl (—OH) is a functional group which relatively easily causes substitution reaction with diazo group. When nano-silicon particles react with diazo compound, a nano-silicon based precursor in which the silicon nano-particles are linked with phenylamine monomers by Si—C covalent bonds is obtained while generating nitrogen. The precursor still has an amino at one side in structure thereof, a silicon composite material with a polyaniline coating layer and Si—C covalent bond can be obtained by polymerizing the added phenylamine with remainder amino of the precursor. Since the silicon nano-particles are surrounded with phenylamine after polymerization on the surface thereof, in this way, the silicon particles with small size are dispersed in nodal points of reticular structure for polyaniline, so as to make the silicon nano-particles have a better dispersity, thereby preventing them from aggregating. Since Si—C covalent bonds exist between polyaniline and the surfaces of the silicon nano-particles and aggregating action is decreased, the coating effect is greatly improved, hardness and binding energy for a negative electrode silicon active material is simultaneously improved. However, the conventional coating is that the silicon nano-particles and phenylamine are directly physically dispersed in water phase and then are polymerized, at this time, coating the silicon nano-particles with polyaniline is achieved by the way of a simple physical adsorption, the coating effect thereof is hardly compared to that of the silicon based composite material with covalent bonds between the silicon nano-particles and polyaniline layer in the present disclosure.

In the preparation method of the silicon based composite material according to the second aspect of the present disclosure, preferably, the nitrite is sodium nitrite, the acidic condition is provided by an organic acid or an inorganic acid. Preferably, the acid is at least one of hydrochloric acid, sulfuric acid, nitric acid, phosphoric acid, formic acid and acetic acid. More preferably, the acid is hydrochloric acid, a mole ratio of p-phenylenediamine to sodium nitrite is 1:(1.5˜3), a mole ratio of p-phenylenediamine to hydrochloric acid is 1:(2.7˜5.4).

In the preparation method of the silicon based composite material according to the second aspect of the present disclosure, a mole ratio of the silicon nano-particles to p-phenylenediamine is 1:(0.75˜1.5) in the step of adding the silicon nano-particles into the solution in which diazotization reaction has achieved.

In the preparation method of the silicon based composite material according to the second aspect of the present disclosure, preferably, the oil phase employs cyclohexane and Tween-80, the water phase employs deionized water and ethanol, wherein a volume ratio of cyclohexane to Tween-80 is 9:1; a volume ratio of deionized water to ethanol is 1:1; a volume ratio of the water phase to the oil phase is 40:100.

In the preparation method of the silicon based composite material according to the second aspect of the present disclosure, a ratio of a weight of the nano-silicon based precursor to a volume of the microemulsion is 18 g/L˜28 g/L; pH is adjusted to 1 with hydrochloric acid; a weight ratio of the added phenylamine monomer to the nano-silicon based precursor is (1.25˜2.5):1.

In the preparation method of the silicon based composite material according to the second aspect of the present disclosure, preferably, the initiator contains ammonium persulfate, sodium dodecylbenzene sulfonate and hexadecyl trimethyl ammonium bromide; a mole ratio of ammonium persulfate to sodium dodecylbenzene sulfonate to hexadecyl trimethyl ammonium bromide to the added phenylamine monomer is (0.1˜0.4):(0.01˜0.04):(0.01˜0.04):1.

In the preparation method of the silicon based composite material according to the second aspect of the present disclosure, preferably, the polymerization reaction is conducted at 10° C.˜25° C.

Next a use of the silicon based composite material according to a third aspect of the present disclosure will then be described, namely a use of the silicon based composite material according to the first aspect of the present disclosure as a negative electrode active material of a lithium-ion battery.

Finally, examples, comparative examples and test results of the silicon based composite material, and the preparing method and the use thereof according to the present disclosure, will be described.

### Example 1

Preparation of a precursor:

20 g of p-phenylenediamine was added into 500 mL (1 mol/L) of hydrochloric acid (HCl) solution, and stirring was performed in a thermostat of 10° C. at a rotating speed of 150 rpm for 10 minutes;

100 mL (5.797 mol/L) of sodium nitrite (NaNO₂) solution was dropped into the hydrochloric acid solution at a speed of 10 mL/min, and stirring was continuously performed at a rotating speed of 150 rpm for 10 minutes;

3.54 g of silicon nano-particle (D50, 40 nm) was added into the solution, stirring was performed at a rotating speed of 300 rpm for 10 minutes, filtering was performed under vacuum, and washing was performed with tetrahydrofuran and ethanol and then with deionized water to reach an oil-free state, followed by baking in a vacuum tank for 6 hours, to obtain 3.70 g of the precursor (in which the silicon nano-particles were linked with phenylamine monomers after diazotization reaction and substitution reaction);

Preparation of a composite material:

20 mL of ethanol and 20 mL of deionized water were uniformly mixed, 90 mL of cyclohexane and 10 mL of Tween-80 were uniformly mixed, and then a total volume of 40 mL of ethanol and deionized water (a water phase) and a total volume of 100 mL of cyclohexane and Tween-80 (an oil phase) were stirred at a rotating speed of 300 rpm for 10 minutes, to form a microemulsion;

2.8 g of the precursor which was the silicon nano-particles after diazotization reaction and substitution reaction was added into 140 mL of the microemulsion, and pH was adjusted to 1 with 37.5% hydrochloric acid; after pH maintained stable, 7 g of phenylamine monomer was added, and then stirring was performed for 10 minutes;

3.43 g of ammonium persulfate, 0.52 g of sodium dodecylbenzene sulfonate and 0.55 g of hexadecyl trimethyl ammonium bromide were dissolved into 5 mL of deionized water; after uniformly mixed, the mixture was added into the microemulsion, and reaction was conducted at a rotating speed of 150 rpm for 2 hours at 15° C.; after the reaction was completed, filtering was performed under vacuum, and then washing with deionized water was performed to reach an oil-free state and baking was performed in a vacuum tank for 4 hours, by which a product A1 was obtained, a weight of the product A1 was 4.3 g; with TG thermogravimetric analysis, a weight ratio of silicon to polyaniline in the product A1 was 65:35.

### Example 2

Preparation of a precursor:

10 g of p-phenylenediamine was added into 500 mL (1 mol/L) of sulfuric acid (H₂SO₄) solution, and stirring was performed in a thermostat of 10° C. at a rotating speed of 150 rpm for 10 minutes;

50 mL (5.797 mol/L) of sodium nitrite (NaNO₂) solution was dropped into the sulfuric acid (H₂SO₄) solution at a speed of 10 mL/min, and stirring was continuously performed at a rotating speed of 150 rpm for 10 minutes;

3.54 g of the silicon nano-particle (D50, 100 nm) was added into the solution, stirring was performed at a rotating speed of 300 rpm for 10 minutes, filtering was performed under vacuum, and washing was performed with tetrahydrofuran and ethanol and then with deionized water to reach an oil-free state, followed by baking in a vacuum tank for 6 hours, to obtain 3.61 g of the precursor;

Preparation of a composite material:

20 mL of ethanol and 20 mL of deionized water were uniformly mixed, 90 mL of cyclohexane and 10 mL of Tween-80 were uniformly mixed, and then a total volume of 40 mL of ethanol and deionized water (a water phase) and a total volume of 100 mL of cyclohexane and Tween-80 (an oil phase) were stirred at a rotating speed of 300 rpm for 10 minutes, to form a microemulsion;

2.8 g of the precursor (which was the silicon nano-particles after diazotization reaction and substitution reaction) was added into 140 mL of the microemulsion, and pH was adjusted to 1 with 37.5% hydrochloric acid; after pH maintained stable, 7 g of phenylamine monomer was added, and then stirring was performed for 10 minutes;

3.43 g of ammonium persulfate, 0.52 g of sodium dodecylbenzene sulfonate and 0.55 g of hexadecyl trimethyl ammonium bromide were dissolved into 5 mL of deionized water; after uniformly mixed, the mixture was added into the microemulsion, and reaction was conducted at a rotating speed of 150 rpm for 2 hours at 15° C.; after the reaction was completed, filtering was performed under vacuum, and then washing with deionized water was performed to become oil-free and baking was performed in a vacuum tank for 4 hours, by which product A2 was obtained, a weight of the product A2 was 4.3 g; with TG thermogravimetric analysis, a weight ratio of silicon to polyaniline in the product A2 was 68:32.

### Example 3

Preparation of a precursor:

20 g of p-phenylenediamine was added into 500 mL (1 mol/L) of hydrochloric acid (HCl) solution, and stirring was performed in a thermostat of 10° C. at a rotating speed of 150 rpm for 10 minutes;

50 mL (5.797 mol/L) of sodium nitrite (NaNO₂) solution was dropped into the hydrochloric acid (HCl) solution at a speed of 10 mL/min, and stirring was continuously performed at a rotating speed of 150 rpm for 10 minutes;

3.54 g of silicon nano-particle (D50, 10 nm) was added into the solution, stirring was performed at a rotating speed of 300 rpm for 10 minutes, filtering was performed under vacuum, and washing was performed with tetrahydrofuran and ethanol and then with deionized water to reach an oil-free state, followed by baking in a vacuum tank for 6 hours, to obtain 3.70 g of the precursor;

Preparation of a composite material:

20 mL of ethanol and 20 mL of deionized water were uniformly mixed, 90 mL of cyclohexane and 10 mL of Tween-80 were uniformly mixed, and then a total volume of 40 mL of ethanol and deionized water (a water phase) and a total volume of 100 mL of cyclohexane and Tween-80 (an oil phase) were stirred at a rotating speed of 300 rpm for 10 minutes, to form a microemulsion;

2.8 g of the precursor (which was the silicon nano-particles after diazotization reaction and substitution reaction) was added into 140 mL of the microemulsion, and pH was adjusted to 1 with 37.5% hydrochloric acid (HCl); after pH maintained stable, 3.5 g of phenylamine monomer was added, and then stirring was performed for 10 minutes;

3.43 g of ammonium persulfate, 0.52 g of sodium dodecylbenzene sulfonate and 0.55 g of hexadecyl trimethyl ammonium bromide were dissolved into 5 mL of deionized water; after uniformly mixed, the mixture was added into the microemulsion, and reaction was conducted at a rotating speed of 150 rpm for 2 hours at 15° C.; after the reaction was completed, filtering was performed under vacuum, and then washing with deionized water was performed to reach an oil-free state and baking was performed in a vacuum tank for 4 hours, by which product A3 was obtained, a weight of product A3 was 3.1 g; with TG thermogravimetric analysis, a weight ratio of silicon to polyaniline in the product A3 was 85:15.

### Example 4

20 g of p-phenylenediamine was added into 500 mL (1 mol/L) of hydrochloric acid (HCl) solution, and stirring was performed in a thermostat of 10° C. at a rotating speed of 150 rpm for 10 minutes;

100 mL (5.797 mol/L) of sodium nitrite (NaNO₂) solution was dropped into the hydrochloric acid solution at a speed of 10 mL/min, and stirring was continuously performed at a rotating speed of 150 rpm for 10 minutes;

3.54 g of silicon nano-particles (D50, 40 nm) was added in the solution, stirring was performed at a rotating speed of 300 rpm for 10 minutes, filtering was performed under vacuum, and washing was performed with tetrahydrofuran and ethanol and then with deionized water to reach an oil-free state, followed by baking in a vacuum tank for 6 hours, to obtain 3.70 g of the precursor;

Preparation of a composite material:

20 mL of ethanol and 20 mL of deionized water were uniformly mixed, 90 mL of cyclohexane and 10 mL of Tween-80 were uniformly mixed, and then a total volume of 40 mL of ethanol and deionized water (a water phase) and a total volume of 100 mL of cyclohexane and Tween-80 (an oil phase) were stirred at a rotating speed of 300 rpm for 10 minutes, to form a microemulsion;

2.8 g of the precursor (which was the silicon nano-particles after diazotization reaction and substitution reaction) was added into 100 mL of the microemulsion, and pH was adjusted to 1 with 37.5% hydrochloric acid (HCl); after pH maintained stable, 5.6 g of phenylamine monomer was added, and then stirring was performed for 10 minutes;

3.43 g of ammonium persulfate, 0.52 g of sodium dodecylbenzene sulfonate and 0.55 g of hexadecyl trimethyl ammonium bromide were dissolved into 5 mL of deionized water; after uniformly mixed, the mixture was added into the microemulsion, and reaction was conducted at a rotating speed of 150 rpm for 2 hours at 25° C.; after the reaction was completed, filtering was performed under vacuum, and then washing with deionized water was performed to reach an oil-free state and baking was performed in a vacuum tank for 4 hours, by which a product A4 was obtained, a weight of the product A4 was 6.3 g; with TG thermogravimetric analysis, a weight ratio of silicon to polyaniline in the product A4 was 72:28.

### Comparative Example 1

20 mL of ethanol and 20 mL of deionized water were uniformly mixed, 90 mL of cyclohexane and 10 mL of Tween-80 were uniformly mixed, and then a total volume of 40 mL of ethanol and deionized water (a water phase) and a total volume of 100 mL of cyclohexane and Tween-80 (an oil phase) were stirred at a rotating speed of 300 rpm for 10 minutes, to form a microemulsion;

2.8 g of silicon nano-particle was added into 140 mL of the microemulsion, and pH was adjusted to 1 with 37.5% hydrochloric acid; after pH maintained stable, 7 g of phenylamine monomer was added, and then stirring was performed for 10 minutes;

3.43 g of ammonium persulfate, 0.52 g of sodium dodecylbenzene sulfonate and 0.55 g of hexadecyl trimethyl ammonium bromide were dissolved into 5 mL of deionized water; after uniformly mixed, the mixture was added into the microemulsion, and reaction was conducted at a rotating speed of 150 rpm for 2 hours; after the reaction was completed, filtering was performed under vacuum, and then washing with deionized water was performed to reach an oil-free state and baking was performed in a vacuum tank for 4 hours, by which a product S1 was obtained, a weight of the product S1 was 6.3 g; with TG thermogravimetric analysis, a weight ratio of silicon to polyaniline in the product S1 was 70:30.

### Comparative Example 2

20 g of p-phenylenediamine was added into 500 mL (1 mol/L) of hydrochloric acid (HCl) solution, and stirring was performed in a thermostat of 10° C. at a rotating speed of 150 rpm for 10 minutes;

100 mL (5.797 mol/L) of sodium nitrite (NaNO₂) solution was dropped into the hydrochloric acid solution at a speed of 10 mL/min, and stirring was continuously performed at a rotating speed of 150 rpm for 10 minutes;

3.54 g of silicon nano-particle (D50, 40 nm) was added into the solution, stirring was continuously performed at a rotating speed of 300 rpm for 10 minutes, filtering was performed under vacuum, and washing was performed with tetrahydrofuran and ethanol and then with deionized water to reach an oil-free state, followed by baking in a vacuum tank for 6 hours, to obtain 3.70 g of the precursor, a product S2 was obtained; with TG thermogravimetric analysis, a weight ratio of silicon to polyaniline in the product S2 was 95:5.

Finally, test results of performances for lithium-ion batteries according to the examples 1-4 and the comparative examples 1-2 will be presented.

(1) Test of Indentation Hardness for the Composite Material

After 0.9 g of each of the composite materials of the examples 1-4 and the comparative examples 1-2 was uniformly stirred with 6.67 g of a solution comprising 1.5% by weight of CMC to form a mixed slurry, the mixed slurry was coated on a stainless steel plate with a size of 3 cm*3 cm, and a coating thickness was limited to 10 μm by a slit; and then baking was performed in a vacuum tank for 4 hours, so that a negative electrode active material was obtained. Indentation hardness was tested by a method in which 0.6N load and indentation depth of 0.5 μm were employed with a nanoindentor. Result of each of the examples and the comparative examples was shown in Table 1.

(2) Tests of Lithium Deintercalation Capacity Per Gram and Cycle Performances for the Composite Materials

0.9 g of each of the composite materials of the examples 1-4 and the comparative examples 1-2 was uniformly stirred with 0.05 g of Super-P and 0.05 g of PVDF in NMP to obtain a slurry, and the slurry was coated on a copper foil with a thickness of 8 μm, baking was performed in a vacuum tank for 4 hours, after being cooled down, a circular electrode sheet with a diameter of 14 mm was formed by punching. Polypropylene resin was taken as a separator and lithium plate with a diameter of 16 mm was taken as a counter electrode (negative electrode), so that 2025 button battery was prepared.

Test of lithium deintercalation capacity per gram: after 2025 button battery standed by for 1 day, the battery with a voltage of higher than 2.5V was discharged to 0.01V with constant current of 0.25 mA and then was discharged to 0.005V with current of 0.05 mA, followed by standby for 5 minutes, subsequently, the battery was charged to 1.5V with constant current of 0.25 mA. And lithium deintercalation capacity per gram for the silicon based composite material was obtained in accordance with charge capacity being equal to charge time multiplied by charge current (constant-current).

Test of cycle performance: after 2025 button battery standed by for 1 day, the battery with a voltage of higher than 2.5V was discharged to 0.01V with a constant current of 0.25 mA and then was discharged to 0.005V with a current of 0.05 mA, followed by standby for 5 minutes, subsequently, the battery was charged to 1.5V with constant current of 0.25 mA.

Charge/discharge in such a manner was performed for 150 cycles, and charge capacities at the 20^{th}, 50^{th} and 150^{th} cycle respectively divided by charge capacity of the first cycle were cycle retention rates at the 20^{th}, 50^{th} and 150^{th} cycles respectively. Result of each of the examples and the comparative examples was shown in Table 1.

TABLE1
test of performances for the lithium-ion batteries in Examples 1-4
and Comparative examples 1-2

| | | | | | Cycle | Cycle | Cycle |
|---|---|---|---|---|---|---|---|
| | | | | Lithium | Retention | Retention | Retention |
| | Material | Indentation | Electric | Deintercalation | Rate on | Rate on | Rate on |
| | Serial | Hardness | Conductivity | Capacity per | the 20^{th} | the 50^{th} | the 150^{th} |
| | No. | (Gpa) | (S/cm) | Gram (mAh/g) | cycle (%) | cycle (%) | cycle (%) |
| Example 1 | A1 | 3.5 | 4.63 | 2145.6 | 95.2 | 90.6 | 76.9 |
| Example 2 | A2 | 3.4 | 3.42 | 2096.8 | 93.1 | 87.9 | 73.5 |
| Example 3 | A3 | 2.6 | 1.98 | 2547.5 | 81.5 | 74.5 | 54.2 |
| Example 4 | A4 | 2.9 | 3.15 | 2254.9 | 86.3 | 78.5 | 65.9 |
| Comparative example 1 | S1 | 0.6 | 3.02 | 1745.1 | 71.8 | 54.6 | 28.4 |
| Comparative example 2 | S2 | 2.3 | 0.02 | 2956.4 | 5.1 | 3.2 | 1.1 |

It may be seen from Table 1 that the silicon based composite materials obtained by grafting reaction in the examples 1-4 were increased in hardness and meanwhile the lithium-ion batteries were obviously improved in electrochemical performances when the silicon based composite materials serve as the negative electrode active materials, for example, lithium deintercalation capacity per gram was increased and cycle retention rate of the battery was prolonged. However, it may be seen from the comparative example 2 that the material with conducting grafting reaction but without conducting the second step (which was a polymerization reaction) had a performance close to nano-silicon, so that cycle retention rate for the battery was low.

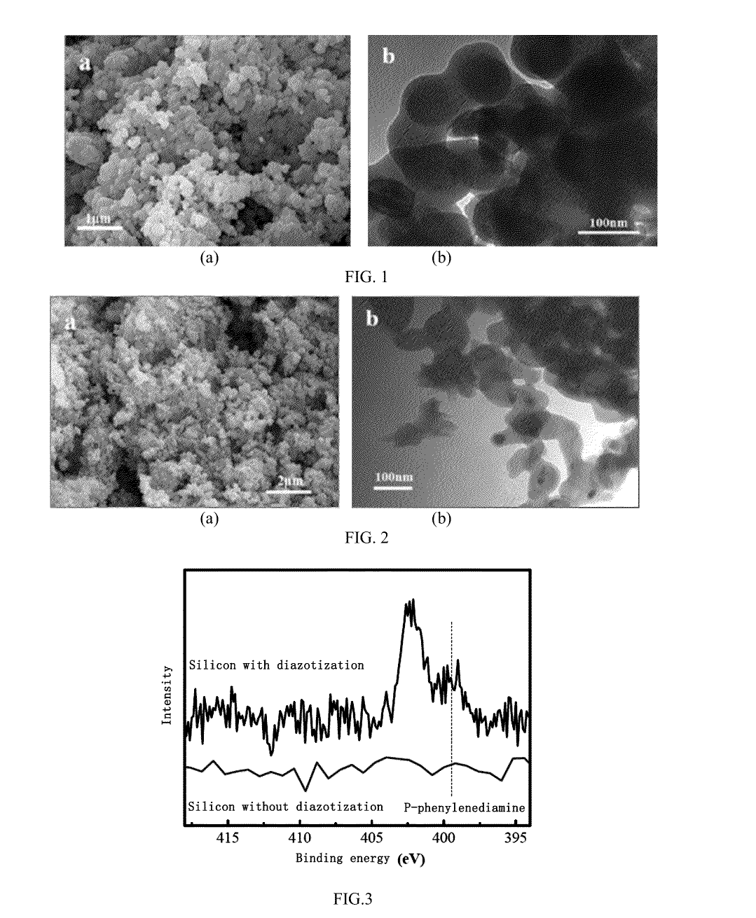

As shown in FIG. 1 and FIG. 2, FIG. 1 was SEM(a) and TEM(b) photographs of the silicon based composite material of the example 1. It may be seen from FIG. 1(a) that dispersity of the silicon based composite material was relatively uniform as a whole, spherical particles were linked with each other. It may be seen from FIG. 1(b) that the silicon based composite material exhibit a reticular structure with podiform, that is to say, polyanilines were uniformly coated around nano-silicon as kernel and were linked with each other, so as to integrally form a reticular structure. And FIG. 2 was SEM(a) and TEM(b) photographs of the silicon based composite material of the comparative example 1, it may be seen from FIG. 2(a) that dispersity of the silicon based composite material was poor as a whole, and contained particles without perfect spherical shape. It may be seen from FIG. 2(b) that silicon particles (which were a relative dark region) and polyanilines (which were a relative light region) were disordered, overall particles were relatively loose and particles having a reticular structure with podiform were not exhibited, the performance in being coated for the silicon particles was poor.

As shown in XPS characterization of FIG. 3, the precursor after diazotization reaction (namely, phenylamine monomer was grafted at the surface of silicon nano-particle) comprised a p-phenylenediamine structure, but the corresponding structure was not appeared in nano-silicon without diazotization reaction, it may prove that diazotization reaction of nano-silicon with phenylamine occurred and phenylamine monomer had been grafted at the surface of nano-silicon.

What is claimed is:

1. A silicon based composite material, comprising silicon nano-particles and polyaniline coating layers on surfaces of the silicon nano-particles, Si—C covalent bonds being formed between the silicon nano-particles and the polyaniline coating layers.

2. The silicon based composite material according to claim 1, wherein an electric conductivity of the silicon based composite material is 1˜6.5 S/cm.

3. The silicon based composite material according to claim 2, wherein the electric conductivity of the silicon based composite material is 1.98˜4.63 S/cm.

4. The silicon based composite material according to claim 1, wherein a particle size D50 of the silicon nano-particles is 10˜100 nm.

5. The silicon based composite material according to claim 1, wherein in the silicon based composite material, a weight ratio of the silicon nano-particles to the polyaniline coating layers is (45˜85):(55˜15).

6. The silicon based composite material according to claim 1, wherein a hardness of the silicon based composite material is 1.4˜3.5 GPa.

7. The silicon based composite material according to claim 6, wherein the hardness of the silicon based composite material is 2.6˜3.5 GPa.

8. A preparation method of a silicon based composite material, comprising steps of:
conducting diazotization reaction under nitrite and an acidic condition by using p-phenylenediamine (H₂N—Ar—NH₂) to generate diazonium salt;
conducting substitution reaction by adding silicon nano-particles into a solution in which the diazotization reaction has achieved, to obtain a nano-silicon based precursor in which phenylamine monomers are linked to surfaces of the silicon nano-particles by Si—C covalent bonds;
adding the nano-silicon based precursor into a microemulsion formed by mixing an oil phase with a water phase, adjusting pH of the microemulsion, and then adding phenylamine monomer;
conducting polymerization reaction of phenylamine by adding an initiator polymerizing phenylamine into the microemulsion, to obtain the silicon based composite material in which the surfaces of the silicon nano-particles are coated with polyaniline layers.

9. The preparation method of the silicon based composite material according to claim 8, wherein the nitrite is sodium nitrite, the acidic condition is provided by an organic acid or an inorganic acid.

10. The preparation method of the silicon based composite material according to claim 9, wherein the acid is at least one of hydrochloric acid, sulfuric acid, nitric acid, phosphoric acid, formic acid and acetic acid.

11. The preparation method of the silicon based composite material according to claim 10, wherein the acid is hydrochloric acid, a mole ratio of p-phenylenediamine to sodium nitrite is 1:(1.5˜3), a mole ratio of p-phenylenediamine to hydrochloric acid is 1:(2.7˜5.4).

12. The preparation method of the silicon based composite material according to claim 8, wherein a mole ratio of the silicon nano-particles to p-phenylenediamine is 1:(0.75˜1.5) in the step of adding the silicon nano-particles into the solution in which diazotization reaction has achieved.

13. The preparation method of the silicon based composite material according to claim 8, wherein the oil phase employs cyclohexane and Tween-80, the water phase employs deionized water and ethanol.

14. The preparation method of the silicon based composite material according to claim 13, wherein a volume ratio of cyclohexane to Tween-80 is 9:1; a volume ratio of deionized water to ethanol is 1:1; a volume ratio of the water phase to the oil phase is 40:100.

15. The preparation method of the silicon based composite material according to claim 8, wherein a ratio of a weight of the nano-silicon based precursor to a volume of the microemulsion is 18 g/L˜28 g/L; pH is adjusted to 1 with hydrochloric acid; a weight ratio of the added phenylamine monomer to the nano-silicon based precursor is (1.25˜2.5): 1.

16. The preparation method of the silicon based composite material according to claim 8, wherein the initiator contains ammonium persulfate, sodium dodecylbenzene sulfonate and hexadecyl trimethyl ammonium bromide.

17. The preparation method of the silicon based composite material according to claim 16, wherein a mole ratio of ammonium persulfate to sodium dodecylbenzene sulfonate to hexadecyl trimethyl ammonium bromide to the added phenylamine monomer is (0.1˜0.4):(0.01˜0.04):(0.01˜0.04):1.

18. The preparation method of the silicon based composite material according to claim 8, wherein the polymerization reaction is conducted at 10° C.˜25° C.

19. The preparation method of the silicon based composite material according to claim 8, wherein an electric conductivity of the silicon based composite material is 1˜6.5 S/cm.

20. A use of the silicon based composite material as a negative electrode active material for a lithium-ion battery, the silicon based composite material comprising silicon nano-particles and polyaniline coating layers on surfaces of the silicon nano-particles, Si—C covalent bonds being formed between the silicon nano-particles and the polyaniline coating layers.
